(19) United States
(12) Patent Application Publication
(10) Pub. No.: US 2004/0117611 A1
(43) Pub. Date: Jun. 17, 2004

(54) Method and arrangement for secure packet-oriented information transmission

(76) Inventors: Siegfried Huber, Reichertshofen (DE); Karl-August Steinhauser, Munchen (DE); Thomas Zellerhoff, Munchen (DE)

Correspondence Address: MORRISON & FOERSTER LLP, 1650 TYSONS BOULEVARD, SUITE 300, MCLEAN, VA, 22102, US

(21) Appl. No.: 10/221,026

(22) PCT Filed: Jun. 26, 2001
(86) PCT No.: PCT/DE01/02341

(30) Foreign Application Priority Data
Jun. 27, 2000 (DE) 100 31 177.6

(51) Int. Cl. H04L 9/00; H04K 1/00

(52) U.S. Cl. 713/150; 380/28

(57) ABSTRACT

First packets P₂ᵢ with a linear index 2i (i≧0) are transmitted in a first channel K₁, second packets P₂ᵢ₊₁ with a non-linear index 2i+1 are transmitted in a second channel K₂ and third packets P_{XOR} which are formed from two consecutive packets P₂ᵢ, P₂ᵢ₊₁, respectively, by bit-wise XOR are transmitted in a third channel K₃. In this way, secure parallel switching matrices can be advantageously created with only three switching matrices.

### BACKGROUND OF THE INVENTION

Coupling multiples in switching systems often require redundancy in order to attain a high system reliability, despite defects in assemblies, etc. If functions or functional groups fail, it should particularly be assured that none of the information transmitted by these groups becomes lost.

The high system reliability is attained, for example, by doubling the information and transmitting it over two identical coupling multiples. One of the two sets of information—preferably the set that was transmitted error-free—is subsequently transmitted further. An error check is to be performed at the outputs of the two redundant coupling multiples in the information transmission. If the redundant sets of information have both been transmitted error-free, only one set is to be transmitted further.

In the migration of existing communications networks, for example, existing continuous information streams—such as SDH or SONET—are integrated into newly constructed packet-oriented networks, such as IP or ATM. In this case, the capacity required for transmitting the continuous information streams is increased by the addition of packet headers. If, for example, the continuous bit stream of an SDH dedicated connection has a bit rate of 622 Mbit/s, the bit stream has a bit rate of at least 687 Mbit/s following a conversion into an ATM-oriented cell current. This bit rate increases further with the use of an AAL-1 method, because in this method at least one octet of further control information is transmitted in the information portion of the ATM cells, causing the bit rate of the ATM-oriented cell current to increase to at least 701 Mbit/s. If the transmission technology used for the physical connections of the communications network is limited to, for example, a maximum transmission capacity of 622 Mbit/s, the ATM-oriented cell current cannot be transmitted 1:1, because the transmission capacity of the transmission technology used for the physical connections is insufficient.

Methods are known in which the information of this type of traffic flow is divided over two channels in a case such as this. For this purpose, so-called parallel-path coupling multiples are used in switching systems; each of the two channels transmits in a separate coupling multiple. Because a high system reliability is necessary for such a switching system, four coupling multiples are required, because each of the two so-called parallel coupling multiples is secured individually. This is an uneconomical measure.

An alternative method is described in U.S. patent application Ser. No. 09/336,090, which was not published prior to the present application. In this method, the packets are divided and transmitted on two coupling multiples. The divided packets are recombined at the output of the coupling multiples. The high system reliability is achieved through the formation of additional (half-) packets from the divided packets by means of bit-wise XOR, and the transmission of these (half-) packets on a third coupling multiple. In this method, therefore, it is necessary to use at least three coupling multiples. If a packet half is transmitted with errors, it is reconstructed through a repeated, bit-wise XOR between the two packet halves that were transmitted error-free. For reconstructing the original packets in their original sequence, it is proposed to synchronize the three coupling multiples among themselves so as to avoid transit-time differences. This is, however, a complicated task in large switching systems because of, for example, increasingly diverging line lengths in the connecting technology as the size of the system increases. This is especially the case for coupling multiples having a horn structure, which places stringent requirements on the cable layout.

### SUMMARY OF THE INVENTION

In one embodiment of the invention, there is a method for the secured, packet-oriented transmission of information, in which first packets having an even index are transmitted in a first channel, second packets having an odd index are transmitted in a second channel, and third packets formed bit-wise from two consecutive packets are transmitted in a third channel.

Several of the advantages of the invention are listed below:

Secured parallel coupling multiples are advantageously realized with three coupling multiples;

Particularly in the use of horn coupling multiples, the division of the packets into the first and second channels permits larger data throughputs while retaining the optimum horn structure.

In accordance with one aspect of the invention, it is provided that additional information—embodied, for example, as sequence numbers and/or time data—is formed and transmitted for reproducing the original packet sequence.

Other advantages include:

The packets can be transmitted in the separate channels without being synchronized with each other, because the additional information is used to ascertain transit-time differences.

A wide range of switching systems can be realized, because the cabling between coupling multiples and I/O assemblies, which is usually extremely complex, can be arbitrary, i.e., embodied without consideration of resulting transit-time differences.

The channels can be realized without synchronization, that is, asynchronously.

The channels can be realized in asynchronous, redundant coupling multiples. The re-sequencer at the output of the coupling multiples processes three, as opposed to four, packet streams simultaneously.

The described XOR method can be applied advantageously to parallel-path coupling multiples, because the sequence numbers required for the re-sequencer can also be used for the XOR process.

The re-sequencing and the XOR process represent a logical unit, and can be realized in a module.

In accordance with another aspect of the invention, in the use of sequence numbers, their value range is selected such that the transit-time differences that are usually anticipated to occur in the channels can be reliably compensated. This advantageously minimizes the capacity required for transmitting the additional information.

According to still another aspect of the invention, the third packet is characterized with at least one of the two sequence numbers of the consecutive packets. This lays the foundation for indicating the association of the third packet with the two consecutive packets.

In yet another aspect of the invention, it is provided that the bit-wise XOR is respectively applied to two bits having the same position within the two consecutive packets. The formed bit occupies the same position within the third packet as the two bits within the two consecutive packets. Thus, the transmission of position information can be eliminated, which optimizes the capacity available for transmitting the packets.

According to another aspect of the method of the invention, it is provided that, in the transmission of the packets in coupling multiples of a switching system in which internal, system-specific headers precede the packets, the additional information is respectively transmitted into the internal headers. The use of internal headers, which usually occur in such switching systems, omits special methods for transmitting the additional information.

According to another aspect of the method of the invention, at least the internal headers are secured by a checksum. This advantageously prevents the divided information from being combined in incorrect order due to erroneously transmitted additional information.

In accordance with still another aspect of the invention, with an odd number of packets, a further packet is added, which is indicated by the transmission of corresponding control information (claim 9). The last packet is therefore also transmitted securely, because it can be regenerated with the aid of the additional packet and the associated, formed third packet if a loss occurs.

### BRIEF DESCRIPTION OF THE DRAWINGS

The invention is explained in detail below with respect to the figures.

### DETAILED DESCRIPTION OF THE PREEMPTED EMBODIMENT

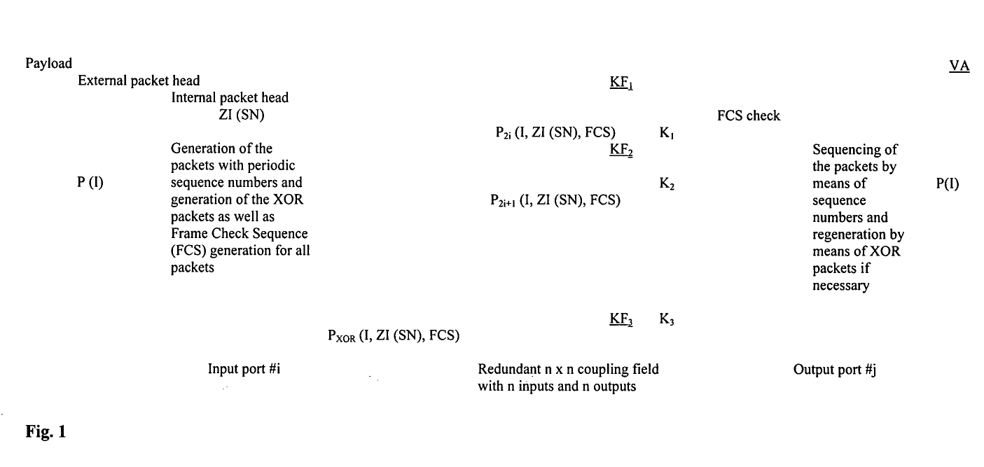

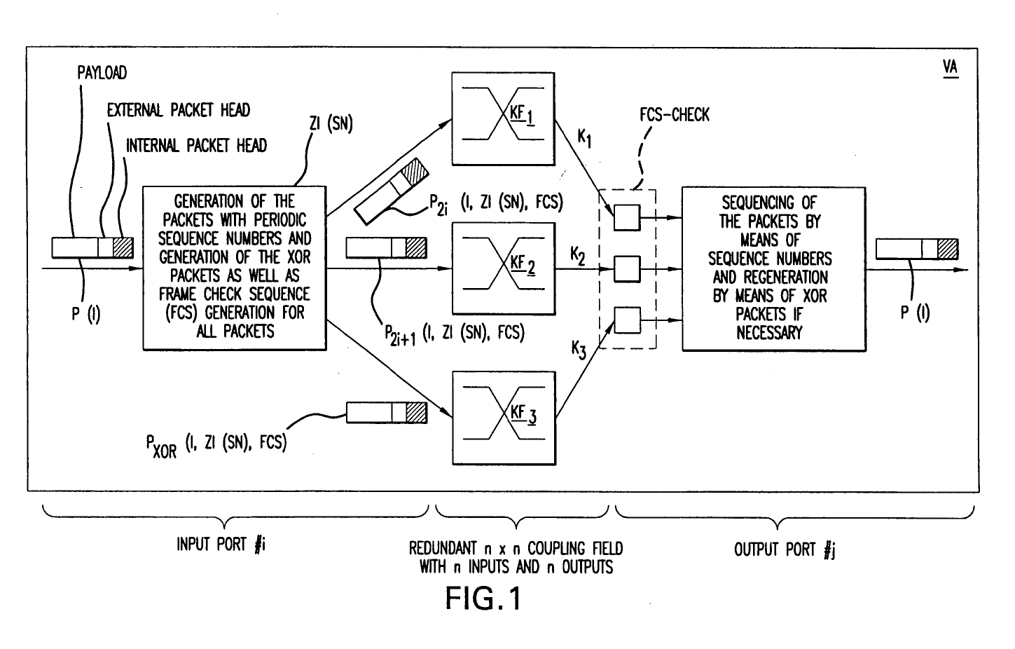

FIG. 1 shows a block diagram of an exemplary arrangement of functional groups according to the invention. FIG. 1 is a block diagram of an exemplary arrangement of functional groups for executing a secured, packet-oriented transmission of information in accordance with the invention. The arrangement according to the invention is embodied as a switching system VA having three coupling multiples KF, in which information is transmitted, for example, in packets P. A channel K is realized from each coupling multiple KF. A functional group for generating first packets P₂ᵢ and second packets P₂ᵢ₊₁, third packets P_{XOR} and additional information ZI from periodic sequence numbers SN and, optionally, from checksums FCS for packets P, is connected in series with the coupling multiples KF. At least one optional function for checking the checksums FCS and a function for ordering the packets P by sequence number SN, and for regenerating erroneous first or second packets P₂ᵢ, P₂ᵢ₊₁, are connected in series at the output of the coupling multiples KF. The information I supplied to the arrangement has, in addition to a payload, an external header—also called cell header—and a system-specific internal cell header. In the case of an ATM transmission of, for example, a 48-byte payload, this type of internal packet P could include a 5-byte external header and an 11-byte internal header.

The examples serve merely in facilitating the understanding of the invention, and are not intended to be limiting. A person of ordinary skill in the art recognizes, for example, that the term packet not only encompasses IP packets, but also other arbitrary transport formats such as cells—especially ATM cells—or frame structures can be used. It is also understood that the invention can be embodied in more comprehensive arrangements, such as subnetworks or arrangements that overlap subnetworks.

For the exemplary embodiment, it is assumed that information I is usually transmitted in small information units P—also called frames, packets, data packets or cells. These packets P include, for example, the information I of the original information stream (also referred to as useful information, data or useful data), as well as additional information (also called overhead) for controlling the process of transmitting the packets P.

An exemplary arrangement for executing the method according to the invention is the embodiment of the switching system VA having three coupling multiples KF. Information I is transmitted at least within the switching system VA on the basis of packets P.

For simplification, it is assumed that the information I is supplied to the switching system VA in packets P. When the packets P enter the switching system VA, they are indexed (in the supply of a continuous SDH/Sonet information stream, it would additionally be necessary to generate the packets P).

Furthermore, two consecutive packets P₂ᵢ, P₂ᵢ₊₁ are used in a bit-wise XOR to form third packets P_{XOR}. For example, the bit-wise XOR is applied to two bits having the same position within the two consecutive packets P₂ᵢ, P₂ᵢ₊₁, with the bit that is formed having the same position within the third packet P_{XOR} as the two bits within the two consecutive packets P₂ᵢ, P₂ᵢ₊₁. The fixed position data allow a receiver of the transmitted packets P to regenerate the information I in its original sequence.

Furthermore, additional information ZI may be formed for reproducing the original sequence of the packets P. This information is present as, for example, sequence numbers SN and/or time data. The packets P are characterized with this information, while the third packets P_{XOR} are characterized with at least one of the two sequence numbers SN of the associated, consecutive packets P₂ᵢ, P₂ᵢ₊₁.

The packets P embodied in this manner are subsequently transmitted in separate channels K, which are realized in the coupling multiples KF of the switching system VA, for example. The additional information ZI is transmitted in, for example, the internal packet headers of the packets P. In the use of sequence numbers SN, their value range is selected such that the transit-time differences that are typically anticipated to occur in the channels K are reliably compensated. The internal headers of the packets P can optionally be secured by a checksum FCS.

After the packets P have been transmitted, the checksum FCS provided in accordance with an embodiment of the invention is checked at the outputs of the coupling multiples KF for each of the three packets P. If the sum is error-free, the packet P is conducted further. Otherwise, it is rejected in order to avoid erroneous functions due to, for example, an incorrect sequence number SN or an incorrect output port number resulting from a faulty routing address.

The packets P are then arranged in their original order. The following situations may occur:

(1) Packets P₂ᵢ, P₂ᵢ₊₁ from coupling multiples KF₁ and KF₂ are present:

→ packets P₂ᵢ, P₂ᵢ₊₁ are outputted (normal case), possibly stored packet P_{XOR} is rejected;

(2) Packet P₂ᵢ from coupling multiple KF₁ is missing, but packets P₂ᵢ₊₁, P_{XOR} from coupling multiples KF₂ and KF₃ are present:

→ packet P₂ᵢ is regenerated through the reversal of the XOR function onto packets P₂ᵢ₊₁, P_{XOR}; packets P₂ᵢ, P₂ᵢ₊₁ are outputted;

(3) Packet P₂ᵢ₊₁ from coupling multiple KF₂ is missing, but packets P₂ᵢ, P_{XOR} from coupling multiples KF₁ and KF₃ are present:

→ packet P₂ᵢ₊₁ is regenerated through the reversal of the XOR function onto packets P₂, P_{XOR}; packets P₂ᵢ, P₂ᵢ₊₁ are outputted;

(4) Packet P_{XOR} from coupling multiple KF₃ is missing, but packets P₂ᵢ, P₂ᵢ₊₁ from coupling multiples KF₁ and KF₂ are present:

→ packets P₂ᵢ, P₂ᵢ₊₁ are outputted;

(5) Packets P from two or all three coupling multiples KF are missing:

→ packets P₂ᵢ, P₂ᵢ₊₁ cannot be regenerated and outputted (=packet loss).

For recognizing a defect in a coupling multiple KF, an alarm can be effected when packet losses occur in one of the coupling multiples KF. The number of successive necessary packet losses is established by a threshold value (threshold) for avoiding false alarms, for example due to sporadic bit errors.

Maintaining the bit synchronization in the transmission layer in asynchronous operation of the arrangement is effected, for example, by empty packets, which are characterized as such in the internal packet header. This portion of the packet header can likewise be excluded from the XOR process. That is, the identification for empty packets is defined such that, following the XOR process over two useful packets, the resulting useful packet remains distinguishable from an empty packet. For example, useful packets can be coded with an identification bit=0, and empty packets can be coded with an identification bit=1, so the resulting XOR useful packet again has the identification bit=0. Empty packets P are immediately rejected at module inputs. They are inserted at the module outputs if an unfilled packet P is awaiting transmission. Thus, the bit synchronization is maintained on the lines, while the internal module functions are protected from a non-utilized load.

1. Method of secured packet-oriented transmission, comprising the following steps:
first packets (P₂ᵢ) with an even index (2i | i≧0) are transmitted in a first channel (K₁) and second packets (P₂ᵢ₊₁) with an odd index (2i+1) in a second channel (K₂),
third packets (P_{XOR}) are formed from two consecutive packets (P₂ᵢ, P₂ᵢ₊₁) by means of bitwise XOR and transmitted in a third channel (K₃).

2. Method according to claim 1, characterized in that supplementary information (ZI) for reestablishment of the original sequence of the packets (P) is formed and transmitted.

3. Method according to claim 2, characterized in that the supplementary information (ZI) is formed as sequence numbers (SN) and/or time references.

4. Method according to claim 3, characterized in that when sequence numbers (SN) are used, their value range is selected to be sufficiently large to ensure that the operating time differences normally to be expected in the channels (K) can be offset.

5. Method according to one of claims 3 or 4, characterized in that the third packet (P_{XOR}) is labeled with at least one of the two sequence numbers (Sn) of the consecutive packets (P₂ᵢ, P₂ᵢ₊₁).

6. Method according to one of the foregoing claims, characterized in that the bitwise XOR is applied to each of two bits with an identical position within the two consecutive packets (P₂ᵢ, P₂ᵢ₊₁), wherein the bit formed in this manner receives the same position within the third packet (P_{XOR}) as the two bits within the two consecutive packets (P₂ᵢ, P₂ᵢ₊₁).

7. Method according to one of the foregoing claims, characterized in that during the transmission of the packets (P) in coupling fields (KF) of a transmission device (VA) in which device-specific internal headers are inserted ahead of each of the packets (P), the supplementary information (ZI) is transmitted in each of the internal headers.

8. Method according to claim 7, characterized in that at least the internal headers are each secured by a check sum (FCS).

9. Method according to one of the foregoing claims, characterized in that in case of an odd number of packets (P), an additional packet (P) is added, which is indicated by transmission of a corresponding piece of control information.

10. Configuration for implementing a method according to one of the foregoing claims.
